(19) United States
(12) Patent Application Publication
(10) Pub. No.: US 2010/0315914 A1
(43) Pub. Date: Dec. 16, 2010

(54) LIGHT IRRADIATION POWER ADJUSTING METHOD AND OPTICAL INFORMATION RECORDING/REPRODUCING APPARATUS

(76) Inventors: Masaki Nakano, Tokyo (JP); Masatsugu Ogawa, Tokyo (JP)

Correspondence Address: Mr. Jackson Chen, 6535 N. STATE HWY 161, IRVING, TX, 75039, US

(21) Appl. No.: 12/526,120

(22) PCT Filed: Jan. 28, 2008
(86) PCT No.: PCT/JP2008/051226

§ 371 Date: Oct. 6, 2009

(30) Foreign Application Priority Data
Feb. 6, 2007 (JP) 2007-026794

(51) Int. Cl. G11B 19/00

(52) U.S. Cl. 369/47.5; G9B/19

(57) ABSTRACT

A light irradiation power adjusting method includes a first recording step, a first reproducing step, a first measuring step, a bias power determining step and a recording power determining step. In the first recording step, an adjustment pattern is recorded to an optical information recording medium while fixing a recording power to a predetermined first power value and while changing a bias power among a plurality of second power values within a predetermined range. In the first reproducing step, the recorded adjustment pattern is reproduced so as to generate a reproduction signal. In the first measuring step, asymmetry values corresponding to the plurality of second power values are measured. In the bias power determining step, an optimum bias power value is determined based on the asymmetry values. In the recording power determining step, an optimum recording power value is determined based on the optimum bias power value.

### TECHNICAL FIELD

The present invention relates to a light irradiation power adjusting method for recording/reproducing information to/from an optical information recording medium by irradiating laser light and an optical information recording/reproducing apparatus which uses the adjusting method. By the way, this application is based upon and claims the benefit of priority from Japanese Patent Application No. 2007-26794, the disclosure of Japanese Patent Application No. 2007-26794 is incorporated herein in its entirety by reference.

### BACKGROUND ART

Optical information recording media (hereafter referred to as “optical discs”), from and to which data are read and written by using laser light, have a high recording density and are capable of large capacity recording. Furthermore, because of noncontact operation, the optical discs are capable of high speed access and have been practically used as large capacity memories. The optical discs are classified into: read-only-memory type optical discs which are capable of only reproduction; recordable (write-once) type optical discs which are capable of only single recording; and rewritable type optical discs which are capable of repeated recording by users.

When an optical disc is the read-only-memory type, an optical information recording/reproducing apparatus detects a reproduction signal based on change in quantity of reflected light from pits as concaves/convexes formed in the optical disc. When an optical disc is the write-once type, the optical information recording/reproducing apparatus detects a reproduction signal based on change in quantity of reflected light from microscopic pits formed in the optical disc or change in reflected light, which is caused by phase change in a phase-change recording film provided in the optical disc.

Presently, as write-once type optical discs used in the market, there are CD-R (Compact Disc-Recordable), DVD-R (Digital Versatile Disc-R), DVD+R and the like. In these optical discs, a recording material including organic dye is used in many cases. Moreover, as a laser light source for writing and reading, employed is a semiconductor laser of a wavelength between about 780 nm and 650 nm. In those optical discs, employed is an organic dye material having an absorption maximum at a wavelength shorter than a wavelength of laser light for recording and reproducing. The organic dye material has a so-called H/L (High-to-Low) property that a light reflection factor of a record mark portion formed by irradiation of laser light is lower than a light reflection factor before the irradiation of laser light. In the formation of the record mark portion, the deformation (shape change) of a resin substrate is used. That is, the resin substrate is heated to a transition temperature or above by the irradiation of laser light, the organic dye is decomposed to generate a negative pressure which causes the deformation of the resin substrate, and the record mark portion is formed.

Moreover, as for next generation optical discs (HD DVD, BD) in which recording density is enhanced, laser light (short wavelength laser) of a wavelength between about 400 nm to 410 nm is employed as a light source for reading and writing from and to the optical discs. Recording layers of write-once type optical discs which are being currently developed for such short wavelength laser can be roughly classified into: recording layers in which inorganic materials are used; and recording layers in which organic dye materials are used. The write-once medium in which inorganic material is used and a recording method for the medium are disclosed in, for example, Japanese Laid Open Patent Application (JP-P2005-116058A). The write-once medium in which organic dye material is used is disclosed in, for example, Japanese Laid Open Patent Application (JP-P2005-297407A).

The inorganic material has an H/L (High-to-Low) property that a reflection factor of a record mark portion formed by irradiation of laser light is lower than a reflection factor before the irradiation of laser light. The organic dye material has an L/H (Low-to-High) property that a reflection factor of a record mark portion formed by irradiation of laser light is higher.

As rewritable type optical discs, there are CD-RW, DVD-RW, DVD+RW, DVD-RAM and the like. Those rewritable type optical discs are media capable of direct overwrite (which may be simply referred to as “overwrite”) recording in which recording is executed while deletion is executed. Laser light is irradiated to those media while the laser light is switched between a recording power relevant to recording and a deleting power relevant to deleting. The light irradiation power is switched correspondingly to mark portions and space portions in order to record information.

Here, recording waveforms showing changes in light irradiation power in recording will be described. FIGS. 1A to 1E show examples of the light irradiation waveforms in recording, which have a plurality of irradiation power levels. FIG. 1A shows a waveform example of an input signal indicating a mark portion and a space portion. As for a waveform when the mark portion is formed, there are a case that the waveform has a pulse train shape in which the recording power is divided with respect to time to be applied in pulses and a case that the recording power is applied in a rectangular shape as a base. FIG. 1B shows an example of recording waveform of a pulse train shape having three levels of irradiation power. The lowest power level in recording is a bottom power Pb, a recording power Pw having a higher irradiation power than the bottom power is applied in pulses correspondingly to the mark portion, and a constant irradiation power is applied correspondingly to the space portion. The constant irradiation power corresponding to the space portion deletes an existing mark when applied to an overwrite medium, and therefore, is referred to as a deleting power Pe in order to distinguish the deleting power Pe from the recording power. However, the constant irradiation power corresponding to the space portion may be referred to as a bias power when the constant irradiation power has no deleting function or the constant irradiation power corresponding to the space portion may be referred to as a bias power as a general name. FIG. 1C shows an example of light irradiation waveform of a pulse train shape, which has two levels of power and has been conventionally used as a waveform corresponding to a non-overwrite recording. When the mark portion is formed, the recording power Pw is applied in pulses. The bias power and the bottom power are set to be the bias powers of the same power level. FIG. 1D shows a waveform example of a rectangle type, which has two levels of power, and the recording power Pw is applied in a rectangular shape when the mark portion is formed. FIG. 1E shows a waveform example having four levels of power, and recording powers Pw1 to Pw3 are applied in a rectangular shape with two ears.

Also with regard to the non-mark portion (space portion), there are several combinations of shapes. However, in its function, the power in the irradiation to the space portion of the overwrite medium is intended to delete the existing mark. On the other hand, as for the write-once type medium, the space portion is not required to be deleted. For this reason, as for the space portion, a light quantity of a level enabling tracking of a light beam on the optical disc is enough and a role of the light quantity is different from the previous case. By the way, Japanese Laid Open Patent Application (JP-P2005-297407A) discloses a recording waveform for next generation optical discs in which recording density is enhanced. The recording waveform has a bias power for a space portion and is used to apply a plurality of power levels including a recording power and a bias power.

Next, conventional art relevant to power adjustment will be described. As for adjustment of recording power, for example, in a case of a DVD-R as a recordable medium, an optical disc apparatus utilizes an area for adjusting recording power (PCA: Power Calibration Area) which is set in a portion of a recording area of the optical disc in order to properly execute the adjustment of recording power (OPC: Optimum Power Control). In HD DVD-R and HD DVD-RW, there is a drive test zone which can be freely used by an optical disc apparatus. The optical disc apparatus adjusts various parameters including recording power by using the drive test zone.

Moreover, adjusting methods of deleting power for the rewritable type optical disc is disclosed in Japanese Laid Open Patent Application (JP-P2003-228847A) and Japanese Laid Open Patent Application (JP-P2004-273074A). In a method of determining optimum deleting power disclosed in Japanese Laid Open Patent Application (JP-P2003-228847A), at first, an 11T signal is recorded at a power of a recording power determined based on a γ method or above. Next, laser light of a plurality of levels of deleting power is irradiated while changing DC deleting power (direct current light). Residual signal amplitude of a signal at the time is measured to determine the optimum deleting power.

Also, Japanese Laid Open Patent Application (JP-P2000-231727A) discloses, with respect to a method of adjusting irradiation power, that BRE (Bit Error Rate) is used as a selection index, that smaller asymmetry is desirable, and that adjustments of a bias power and a peak power are possible independent on the order of the adjustments.

There are various performance indexes used for the power adjustment. For example, jitter or error rate of recorded and reproduced signals is used as a performance index. Also, in a β method, β value, which is determined from reproduction amplitude of a long mark and reproduction amplitude of a short mark through inspection of asymmetry, serves as the performance index. In the γ method, a state is judged from a saturation degree of record mark amplitude. In the β0 method, for example, a correlation between the β value and error amount is determined in advance between an optical disc and an optical disc apparatus, and the β value is used as the performance index. As for a write-once type medium, since the β value changes greatly with respect to the recording power, the β value is easy to be dealt with as the performance index, and thus, used in many cases. It is considered to be good that the value is around zero, however, zero does not necessarily provide the best performance. For example, it may be good that the β0 value is a value slightly deviated from zero, such as +0.05 and −0.07. Accordingly, depending on the correlation between the β value and the error amount, a performance indicated by absolute value of the β value is different.

Furthermore, there is PRSNR (Partial Response SNR) as a performance index for an optical disc of high density. The PRSNR is an evaluation index of signal quality and an alternative of the jitter. It is possible to say that, as the value of the PRSNR is higher, the signal quality is better. Moreover, the PRSNR can be converted into an error rate. As for details including the conversion, please refer to [Japanese Journal of Applied Physics Vol. 43, No. 7B, 2004, pp. 4859-4862 “Signal-to-Noise Ratio in a PRML Detection” S. OHKUBO et al].

Also, Japanese Laid Open Patent Application (JP-P2002-197660A) discloses detecting means corresponding to the asymmetry in the case of using PRML detection. According to this disclosure, the asymmetry can be calculated not only by using the shortest mark but also by using the next shortest mark (space) longer than the shortest mark in place of the shortest mark. Also, Japanese Laid Open Patent Application (JP-P2004-110993A) discloses a recording power selecting method which uses an asymmetry value.

Also, Japanese Laid Open Patent Application (JP-P2002-230770A) discloses a method of adjusting a recording condition for the optical disc through a recording pulse waveform control. Moreover, Japanese Laid Open Patent Application (JP-A-Heisei 10-64064) discloses a determining method of a writing power, a deleting power and a bottom power, in which an asymmetry value, a modulation degree and an error rate are used as performance indexes. Also, Japanese Laid Open Patent Application (JP-A-Heisei 10-124876) discloses a determining method of a recording light quantity for a perforation-recordable type optical disc based on an asymmetry quantity.

As for a conventionally-used disc medium, namely, as for a write-once type optical disc medium which includes a recording layer of organic dye and for which recording and reproducing are executed by using laser light of a wavelength of 650 nm or longer, a power corresponding to a space is unnecessary. This is because there is no necessity of overwriting. The impossibility of overwrite means an advantage that data cannot be rewritten or changed.

On the contrary, as for a write-once type optical disc medium (hereafter referred to as “short wavelength write-once medium) which has been recently developed and from and to which recording and reproducing are carried out by using a short wavelength laser (having a wavelength around 405 nm), at least three power levels are required for optical power in recording. Required are a recording power corresponding to a mark portion and a bias power which is an irradiation power especially corresponding to a space portion and is higher than a conventional one. It is known that a recording quality not only depends on the recording power corresponding to the mark portion but also is influenced greatly by the bias power corresponding to the space portion. Namely, the recording quality of the short wavelength write-once medium is changed depending on both of the recording power and the bias power. Thus, the adjustment of the bias power is important. Conventionally, recording is performed on a write-once type optical disc by using a recording waveform composed of two power levels, and a quality of a record mark is influenced by only a power corresponding to a mark portion. Accordingly, a power corresponding to a space portion is enough when light emission is carried out such that a deviation does not occur in a scanning of beam, and is adjusted not to be greater (higher) in order to reduce an influence thereof. On the other hand, as for the write-once type optical disc medium for the short wavelength laser, a bias power irradiated correspondingly to a space portion is higher than a conventional bias power and has an influence on a quality of a record mark to be formed. Thus, an effect of the bias power differs from a conventional one. Hence, nothing is described with respect to the effect of the bias power, an adjusting method of optical powers in recording, which includes the bias power, and especially an adjusting procedure. Hence, even if only the recording power is adjusted as same as the conventional art, the highest recording quality cannot be attained for the short wavelength write-once medium.

Moreover, as for the optical disc medium which has been recently developed and from and to which recording and reproducing are carried out by using the short wavelength laser and as for a optical disc apparatus, high precision is required for respective parameters. Especially, higher precision is required for recording parameters in recording of information than before, and the recoding parameters are required to be set to optimum values. For this reason, numbers of adjustment targets and parameters are increased, and there is a problem of increased adjustment time. In such situation, it is considered that recording and reproducing are tried for all combinations of recording powers and bias powers so as to carry out adjustment. However, because of increased adjustment time and consumption of many adjustment areas, it is not necessarily good solution.

Also, even in determining an optical power corresponding to a space portion, because of the write-once type medium, a procedure in which an already-recorded mark portion is deleted and the optical power corresponding to the space portion is determined cannot be a solution.

With regard to evaluation scales for determination of powers, a plurality of methods such as β method, γ method, error number, and PRSNR are used to determine a recording power; and residual signal amplitude of a recorded signal is used to determine a deleting power and a bias power. In this way, a process for determining the optical powers by using the plurality of different methods will unavoidably become a complex process. Moreover, its influence causes increase of detecting hardware and increase of control program (control firmware) for controlling apparatus, and it is considered to be a large problem.

### DISCLOSURE OF INVENTION

As mentioned above, increasing are necessities for developing a universal method capable of adjusting light irradiation power in recording at high precision, high accuracy and high efficiency while reducing adjustment time; and for developing a method capable of further suppressing a device cost and reducing device resource.

An object of the present invention is to provide a light irradiation power adjusting method and an optical recording/reproducing apparatus for an optical information recording medium, which capable of adjusting at high accuracy, light irradiation power in recoding to a write-once recording medium in which a recording mark is formed by light beam irradiation and of reducing adjustment time and adjustment area.

In an aspect of the present invention, a light irradiation power adjusting method includes a first recording step, a first reproducing step, a first measuring step, a bias power determining step and a recording power determining step. In the first recording step, an adjustment pattern is recorded to an optical information recording medium while fixing a recording power of a light beam, which is irradiated to the optical information recording medium correspondingly to a mark portion of a code to be recorded, to a predetermined first power value and while changing a bias power of the light beam, which is irradiated correspondingly to a space portion of the code, among a plurality of second power values within a predetermined range. In the first reproducing step, the recorded adjustment pattern is reproduced so as to generate a reproduction signal. In the first measuring step, based on the reproduction signal, asymmetry values respectively corresponding to the plurality of second power values are measured. In the bias power determining step, an optimum bias power value is determined based on the asymmetry values. In the recording power determining step, based on the optimum bias power value, an optimum recording power value as an optimum value of the recording power is determined.

In another aspect of the present invention, an optical information recording/reproducing apparatus includes an optical head unit, controlling means, asymmetry measuring means, bias power determining means, and recording power determining means. The optical head unit records an adjustment pattern to an optical information recording device while switching between a recording power of an light beam, which is irradiated to the optical information recording medium correspondingly to a mark portion of a code to be recorded, and a bias power of the light beam, which is irradiated correspondingly to a space portion of the code. Furthermore, the optical head unit reproduces the recorded adjustment pattern so as to generate a reproduction signal. The controlling means set the recording power and the bias power such that the recording power is fixed to a predetermined first power value and the bias power is changed among a plurality of second power values within a predetermined range. The asymmetry measuring means measure based on the reproduction signal, asymmetry values respectively corresponding to the plurality of second power values. The bias power determining means determine an optimum bias power based on the asymmetry values. The recording power determining means determine an optimum recording power value as an optimum value of the recording power based on the optimum bias power value.

According to the present invention, provided are a light irradiation power adjusting method and an optical recording/reproducing apparatus for an optical information recording medium, which capable of adjusting at high accuracy, light irradiation power in recoding to a write-once recording medium in which a recording mark is formed by light beam irradiation and of reducing adjustment time and adjustment area.

### BRIEF DESCRIPTION OF DRAWINGS

The above objects, effects and features of the present invention will be more apparent from description of exemplary embodiments taken in conjunction with the accompanying drawings, in which:

FIGS. 1A to 1E show examples of light emission waveform in recording;

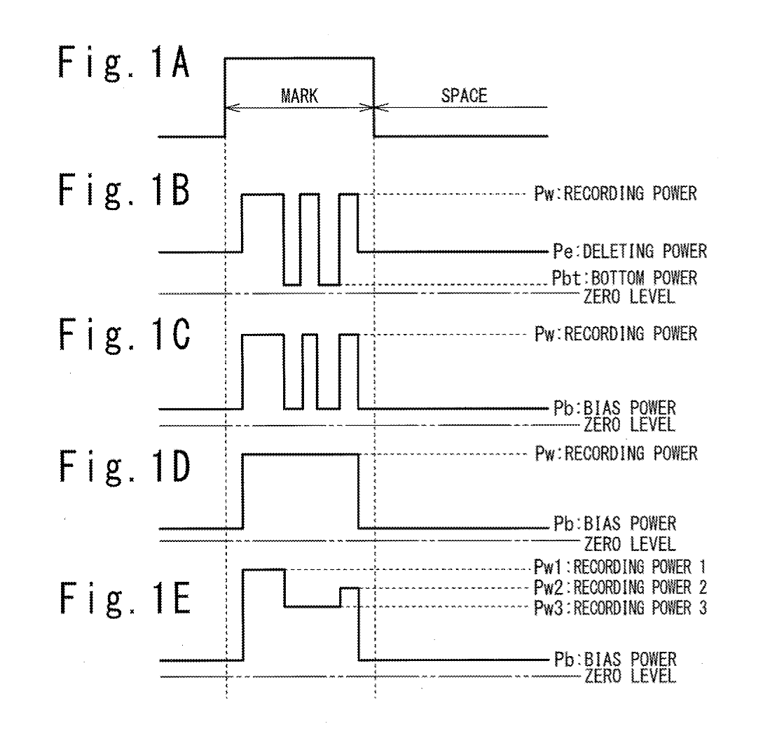

FIG. 2 shows measurement results of a recording power dependence of PRSNR for H/L medium;

FIG. 3 shows plots of 2T asymmetry value which are measured at combinations of recording power Pw and bias power Pb in a case that PRSNR is maximum;

FIG. 4 shows measurement results of relation between bias power Pb and 2T asymmetry value with recording power Pw as parameter;

FIG. 5 shows measurement results of relation between recording power Pw and PRSNR with bias power Pb as parameter;

FIG. 6 shows, as for H/L polarity medium, measurement results of relation between bias power Pb and 2T asymmetry value with recording power Pw as parameter;

FIG. 7 shows measurement results of relation between recording power Pw and PRSNR with bias power Pb as parameter;

FIG. 8 shows measurement results of relation between bias power Pb and asymmetry values corresponding to 2T and 3T patterns in a case that recording power Pw is 10.5 mW;

FIG. 9 shows, as for another H/L polarity medium, measurement results of relation between bias power Pb and asymmetry value and of relation between bias power Pb and PRSNR in a case that recording power Pw is fixed;

FIG. 10 is a block diagram showing a configuration of an information recording/reproducing apparatus according to exemplary embodiments of the present invention;

FIG. 11 is a block diagram showing a configuration of a parameter adjuster according to the exemplary embodiments of the present invention;

FIGS. 12A to 12C show a procedure of an adjusting method of light irradiation power in recording, according to a first exemplary embodiment of the present invention;

FIG. 13 shows measurement results of relation between bias power and asymmetry value in a case that recording power is fixed;

FIG. 14 shows measurement results of relation between recording power and asymmetry value and of relation between recording power and PRSNR in a case that bias power is fixed;

FIGS. 15A to 15C show a procedure of an adjusting method of light irradiation power in recording, according to a second exemplary embodiment of the present invention;

FIG. 16 shows measurement results of relation between bias power and asymmetry value corresponding to 2T;

FIG. 17 shows measurement results of relation between recording power and PRSNR in a case that bias power is fixed;

FIGS. 18A to 18C show a procedure of an adjusting method of light irradiation power in recording, according to a third exemplary embodiment of the present invention;

FIG. 19 shows an example of conversion table;

FIG. 20 shows measurement results of relation between bias power and asymmetry value in a case that recording power is fixed;

FIG. 21 shows an example of a conversion table including correction values, according to the third exemplary embodiment of the present invention;

FIG. 22 shows measurement results of relation between bias power and asymmetry value in a case that recording power is fixed, according to a fourth exemplary embodiment of the present invention;

FIG. 23 shows measurement results of relation between recording power and asymmetry value and of relation between recording power and PRSNR at selected bias power (4.0 mW);

FIG. 24 shows measurement results of relation between recording power and asymmetry value and of relation between recording power and PRSNR in a case that bias power is set to 4.5 mW; and

FIGS. 25A to 25C show light emission waveforms in recording, according to the exemplary embodiments of the present invention.

### BEST MODE FOR CARRYING OUT THE INVENTION

At first, principles of the present invention are described based on collected data. An optical information recording/reproducing apparatus (hereafter referred to as “optical disc apparatus”), which is used for the data collection, includes an optical head of which an LD (Laser Diode) wavelength is 405 nm and NA (Numerical Aperture) is 0.65. As for optical discs, a guide groove for in-groove format is formed on a polycarbonate substrate having a diameter of 120 mm and a thickness of 0.6 mm. As for the density of data recorded on the optical discs, a bit pitch is 0.153 μm and a track pitch is 0.4 μm. Used are medium (L/H medium) in which an organic dye recording film for a short wavelength is used as a recoding film and medium (H/L medium) in which an inorganic recording film for a short wavelength is used as a recording film. Those media are write-once type media to which recording is possible only one time. ETM (Eight to Twelve Modulation) code based on (1,7) RLL (Run Length Limited) is used as modulation/demodulation code.

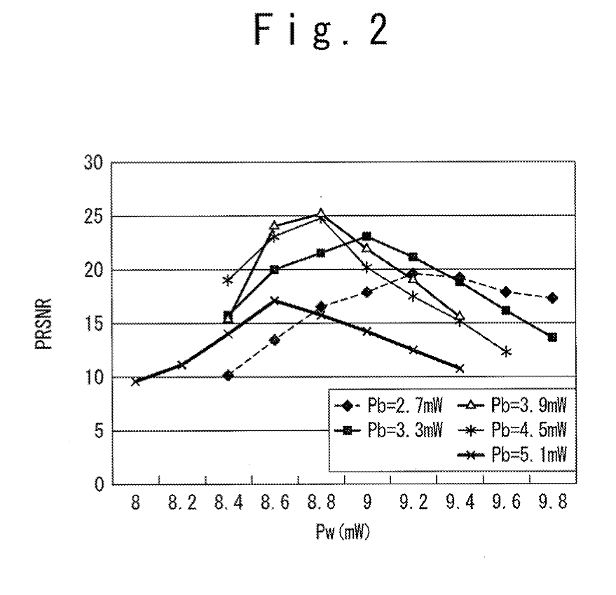

FIG. 2 shows an example of measurement results of recording power Pw dependence of PRSNR in a case of the H/L medium. At this time, a parameter is bias power Pb. As can be understood from FIG. 2, the values of the recording power Pw when the PRSNR takes maximums are different depending on the bias power Pb. That is, when Pb=2.7 mW, the PRSNR takes maximum at Pw=9.2. When Pb=3.3 mW, the PRSNR takes maximum at Pw=9.0 mW. When Pb=3.9 mW, the PRSNR takes maximum at Pw=8.8 mW. When Pb=4.5 mW, the PRSNR takes maximum at Pw=8.8 mW. When Pb=5.1 mW, the PRSNR takes maximum at Pw=8.6 mW. Accordingly, it is found that when the bias power Pb is roughly selected, it is difficult to select the recording power Pw at a high speed and a high precision by using the PRSNR value as an evaluation index.

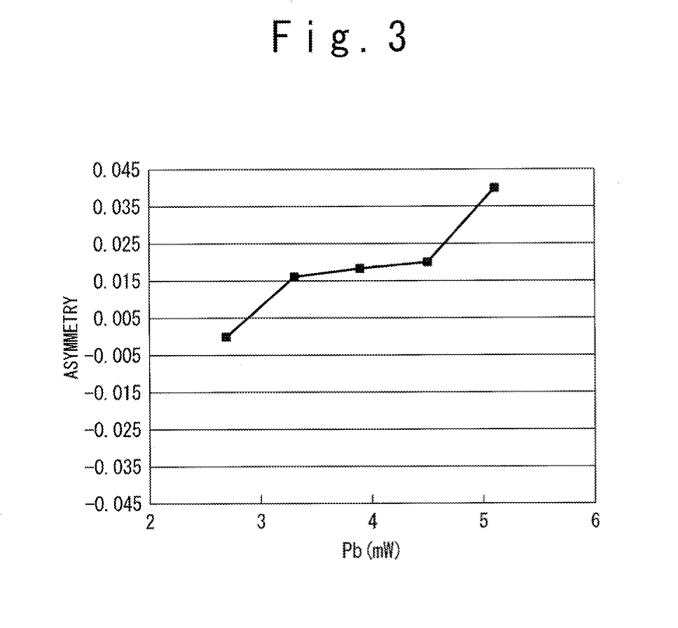

FIG. 3 shows measurement results of 2T asymmetry (2Tβ) at the combination of the bias power Pb and the recording power Pw which provides the maximum of the PRSNR value at the bias power Pb. It is understood that the 2Tβ0 value does not take the same value but takes different values correspondingly to the bias power Pb (recording power Pw). Accordingly, it is understood that it is difficult to select the recording power at high speed simply based on the asymmetry value. Here, the bias power Pb is plotted along the horizontal axes. Even when the recording power Pw is plotted along the horizontal axis, the same can be said.

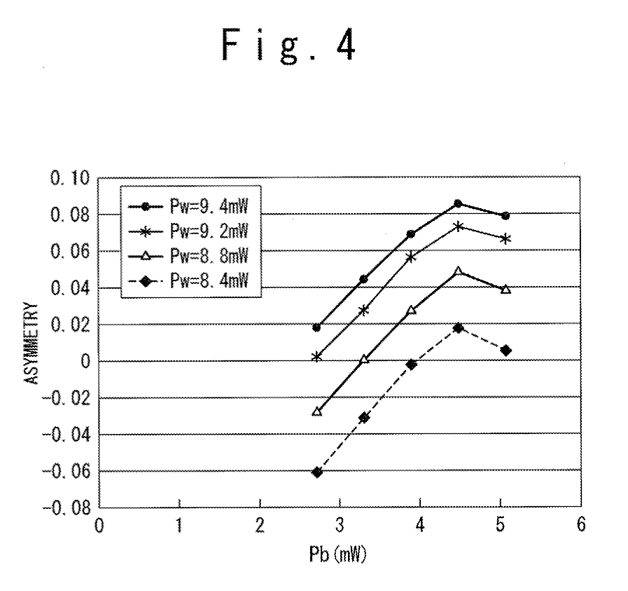

FIG. 4 shows measurement results of the change in the 2T asymmetry value (2Tβ) with respect to the change in the bias power Pb when the recording power Pw is set as the parameter. As can be understood from FIG. 4, although the absolute values of the 2Tβ are different, the 2Tβ0 takes the maximum for any value of the recording power Pw when the bias power is 4.5 mW.

The phenomenon is described in which the asymmetry value is changed with respect to the bias power Pb. On the optical disc, a mark portion is formed mainly because change of state or chemical change occurs in the recording layer material. The change occurs when it exceeds a specific temperature (mark formation arrival temperature). The change in the asymmetry value indicates a state change process in which the bias power corresponding to the space portion causes a reflection factor of the space portion to change to a mark when it goes beyond the specific temperature. Namely, since the change in the reflection factor of the space portion is inverted into the reflection factor polarity opposite to the reflection factor polarity of the space portion until that time when it goes beyond the mark formation arrival temperature, a change occurs in amplitude of reflected light and the asymmetry change is caused. Also, even if irradiation times are the same, the deference of the recording power Pb generates deference of size of area of the optical disc, in which the mark potion is formed when it goes beyond the mark formation arrival temperature. Therefore, it results in the difference of the amplitude in the reproduction and results in the change of absolute value of the asymmetry indicating a balance between a short mark and a long mark. However, since a transition from the space to the mark occurs at the same bias power Pb independent on the size of the mark portion (independent on the recording power Pw), the inversion of the asymmetry value occurs at the bias power Pw which is specific to the respective media.

It was found that such phenomenon conspicuously appears in the medium which requires the adjustment of the bias power when the mark is formed. That is, as for the medium for which there is an involvement of the bias power so that the bias power of the space portion greatly affects a recording quality in place of an involvement to the mark formation so that the lower bias power is simply better or the higher bias power as high as possible is better, unless the bias power is adjusted, the recording quality is deteriorated. By the way, the reflection factor of the space portion, which changes when it goes beyond the specific temperature, is not always inverted, but there is a case that the rate of the amplitude change is changed. For all of the cases, it is common that the asymmetry change is caused when it goes beyond the specific temperature.

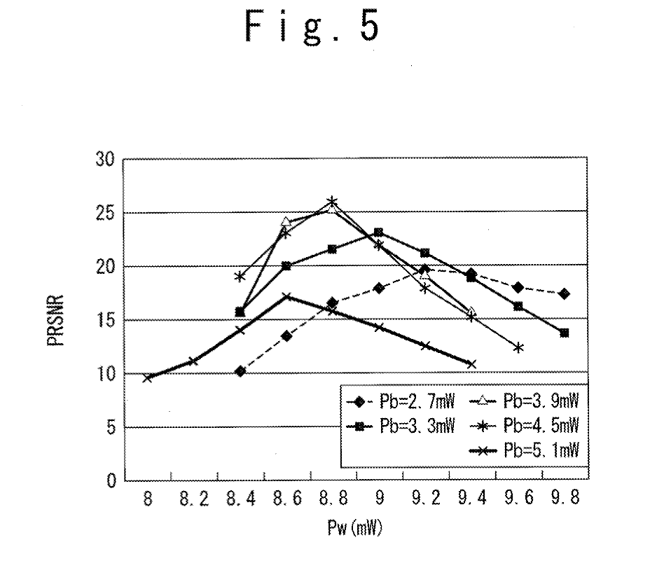

FIG. 5 measurement results of relation between recording power Pw and PRSNR with bias power Pb as parameter. In FIG. 4, at any recording power Pw, the asymmetry 2Tβ0 takes the maximum when the bias power Pb is 4.5 mW. However, from FIG. 5, it is found that the best PRSNR performance is attained when the bias power Pb is 4.5 mW and the recording power Pw is 8.8 mW.

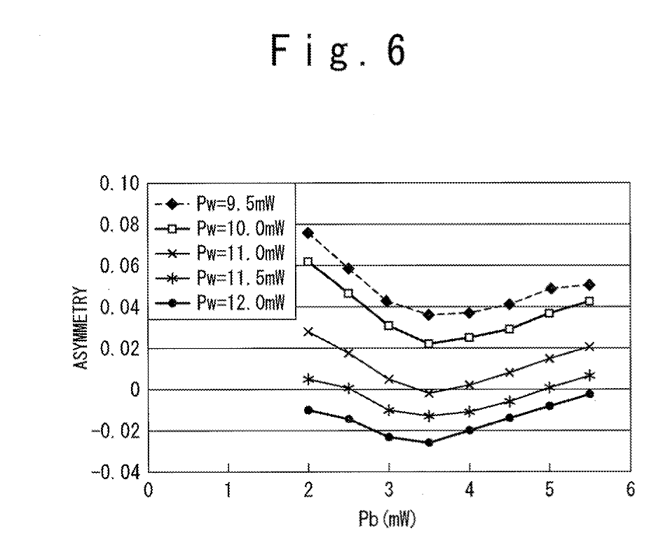

Measurement results for the medium in which the organic dye will be described bellow. FIG. 6 shows measurement results of relation between bias power Pb and 2T asymmetry value 2Tβ with recording power Pw as parameter. Also in this case, similarly, when the bias power Pb is 3.5 mW, the 2T asymmetry value 2Tβ takes the minimum. By the way, the correspondence relation between the reflection factor of the mark portion and the reflection factor of the space portion is opposite to the previously-described case in which the inorganic recording layer is employed. Thus, the manner of the change in the asymmetry value 2Tβ with respect to the bias power Pb is opposite. Thus, the asymmetry value 2Tβ has the minimum value with respect to the change in the bias power Pb. In this way, although the change in the reflection factor is opposite, since the change in the reflection factor of the space portion is inverted at the specific temperature as same as the case of the H/L medium, the phenomenon in which the amplitude change occurs and the asymmetry change occurs can be confirmed to be same as the previous case.

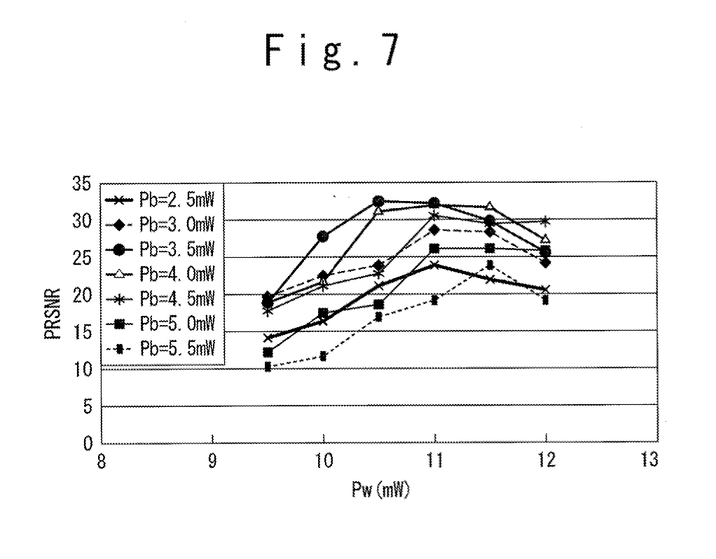

FIG. 7 shows measurement results of relation between recording power Pw and PRSNR with bias power Pb as parameter. In FIG. 6, the 2T asymmetry value 2Tβ takes the minimum when the bias power Pb is 3.5 mW. However, as shown in FIG. 7, in a case that the bias power Pb is 3.5 mW, it is found that the best PRSNR performance is attained when the recording power Pw is 10.5 mW.

Moreover, depending on the medium, there is a case that the performance is further improved at the bias power Pb at which the asymmetry value is slightly deviated from the maximum or the minimum. In this case, it is possible to determine the optimum bias power Pb at a high speed by adjusting the bias power Pb correspondingly to the medium based on the bias power Pb at which the asymmetry value takes the maximum or the minimum. Or, it is possible to determine the optimum bias power Pb at higher precision by searching the bias power in detail with the bias power Pb as the center, at which the asymmetry value takes the maximum or the minimum. At this time, it is preferred to be carried out with the change amount of the bias power Pb being narrow (small). By doing that, the selection of the bias power Pb can be carried out at higher precision and higher speed as compared with a case in which the bias power Pb is changed in a wide range.

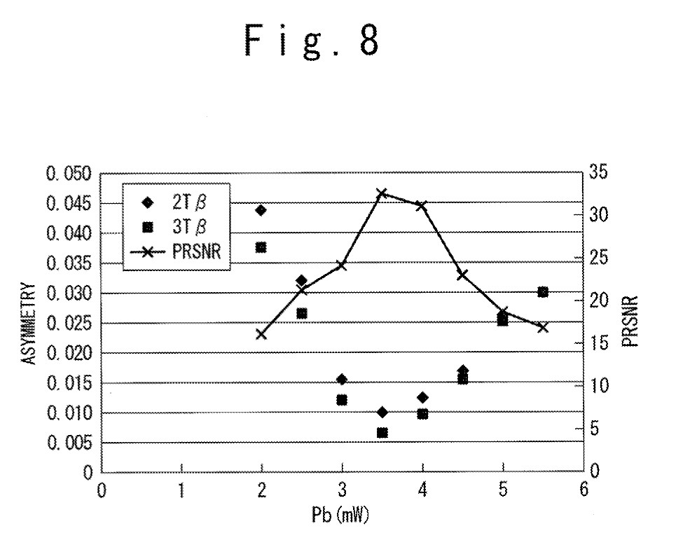

Also, the asymmetry is not necessarily required to be the asymmetry value 2Tβ0 corresponding to the shortest mark space. As shown in FIG. 8, it was found that the detection is possible by using the asymmetry value corresponding to the next shortest mark longer than the shortest mark. FIG. 8 shows, as for the L/H medium, measurement results of relation between bias power Pb and asymmetry value in a case that recording power Pw is 10.5 mW. As the asymmetry, plotted are asymmetry value 2Tβ of 2T and asymmetry value 3Tβ of 3T that is the next shortest mark space longer than 2T in a case of the ETM. Also, in a case of the 3T asymmetry value 3Tβ, observed is a behavior similar to that in a case of the 2T asymmetry value 2Tβ.

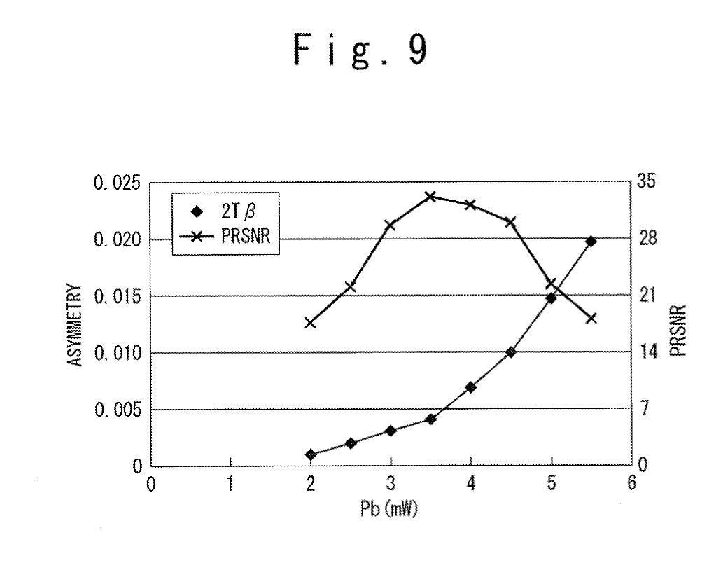

FIG. 9 shows measurement results for an L/H medium other than the medium used in the measurement of FIG. 8. Similarly, a relation between bias power Pb and asymmetry value and a relation between bias power Pb and PRSNR are measured at a constant recording power Pw. As the asymmetry at this time, the 2T asymmetry value 2Tβ is plotted. When the PRSNR takes the best (maximum), the asymmetry value does not take the minimum. However, when the bias power Pb is 3.5 mW, the rate of the amplitude change is changed. Since the rate of the amplitude change is changed, it is found that the asymmetry is changed and the PRSNR takes the maximum.

As mentioned above, even if the recording power Pw is roughly selected, the bias power Pb can be determined by using the asymmetry value (the 2T asymmetry value 2Tβ or the 3T asymmetry value 3Tβ) as an index. The recording power Pw is determined with the bias power Pb being fixed to the determined bias power Pb. It is found that the light irradiation power in recording is determined at a high speed and a high precision by setting the bias power Pb and the recording power Pw as mentioned above.

Also, the optimum bias power value is found to be determined based on a bias power value when asymmetry value of reproduction signals corresponding to respective steps of step wisely-changed bias power Pb takes the maximum or the minimum, or based on bias power Pb when change amount of increase or decrease in the asymmetry value with respect to the change in bias power (gradient of change in the asymmetry value with respect to the bias power Pb is changed).

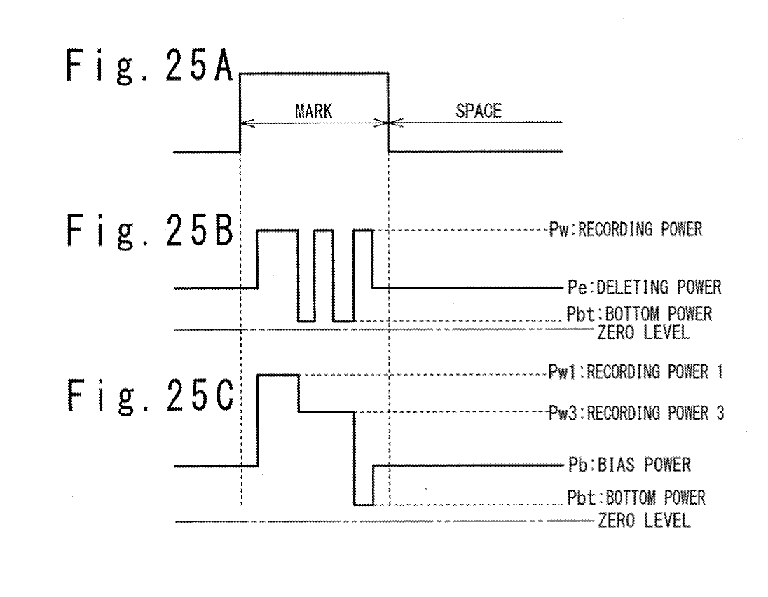

Next, the best mode of carrying out the invention will be described in detail with reference to the drawings. FIGS. 25A to 25C show examples of recording strategy according to exemplary embodiments of the present invention. FIG. 25A shows a waveform example of an input signal indicating a mark portion and a space portion. FIG. 25B shows a pulse train type recording strategy which has three power levels. FIG. 25C shows a rectangle type recording strategy. Since bottom power Pbt has no influence on the present invention, the value of the bottom power is set to a minimum power value of 0.1 mW, which can be set by the information recording/reproducing apparatus.

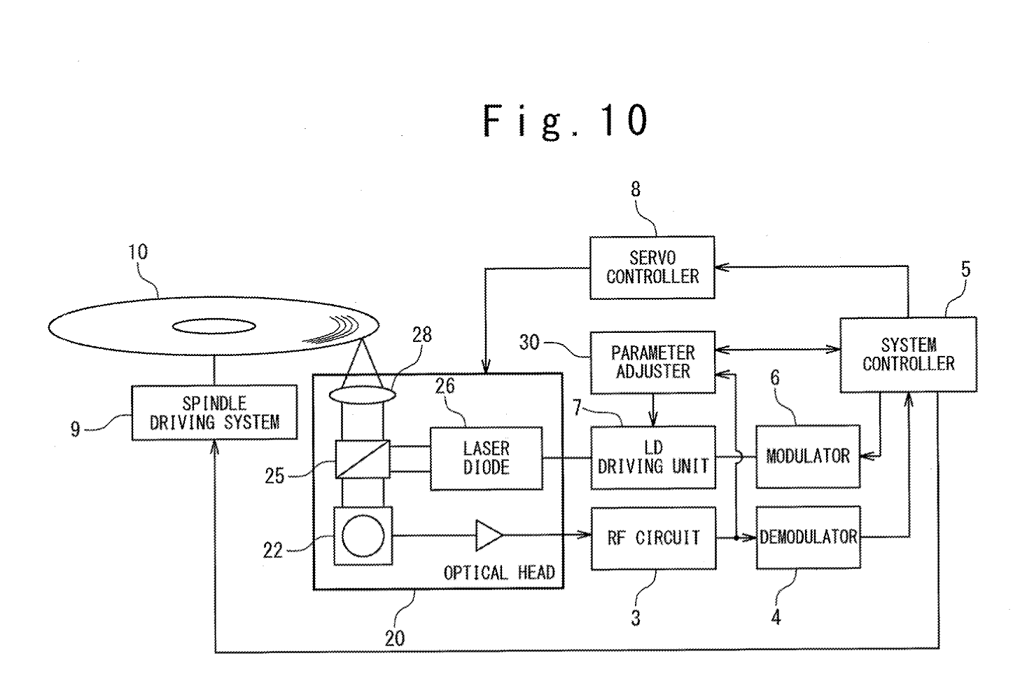

FIG. 10 shows a schematic diagram of an information recording/reproducing apparatus according to a first exemplary embodiment of the present invention. The information recording/reproducing apparatus includes a spindle driving system 9, an optical head unit 20, an RF circuit unit 3, a demodulator 4, a system controller 5, a parameter adjuster 30, a modulator 6, an LD driving unit 7 and a servo controller 8.

The spindle driving system 9 drives an optical disc 10. The optical head unit 20 includes a laser diode (LD) 26, an objective lens 28, a beam splitter 25 and a light detector 22. The optical head unit 20 irradiates light from the laser diode 26 through the objective lens 28 to the optical disc 10 and detects the reflected light from the optical disc 10 by using the light detector 22. The beam splitter 25 reflects the light from the laser diode 26 to the objective lens 28 and passes the reflected light from the optical disc 10 to the light detector 22.

The RF circuit unit 3 carries out a process such as filtering to the input signal. The demodulator 4 demodulates the input signal. The system controller 5 manages the entire of the apparatus. The parameter adjuster 30 adjusts parameters such as powers and judges reproduction signal performance. The modulator 6 modulates a signal to be recorded. The LD driving unit 7 drives the laser diode 20 of the optical head unit 20. The servo controller 8 controls a servo signal.

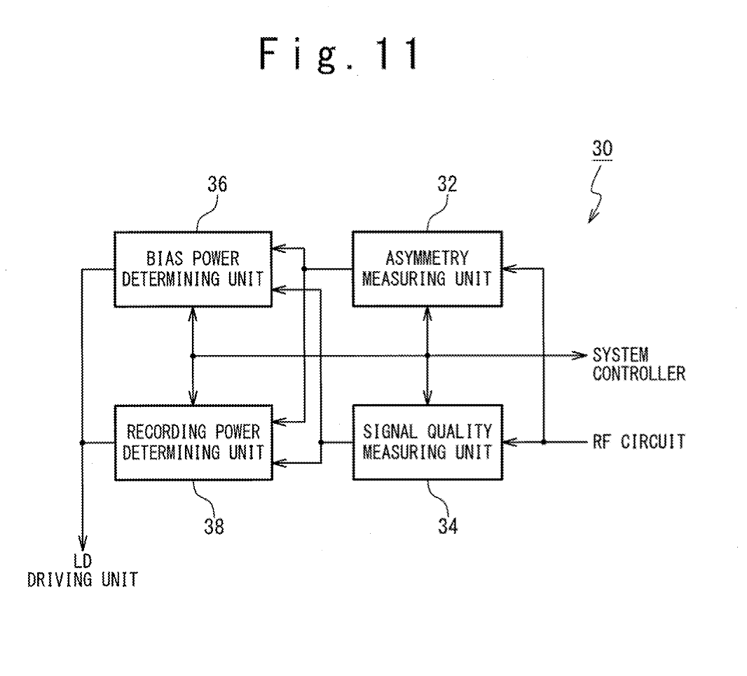

FIG. 11 shows a configuration of the parameter adjuster 30. The parameter adjuster 30 includes an asymmetry measuring unit 32, a signal quality measuring unit 34, a bias power determining unit 36 and a recording power determining unit 38. Each unit of the parameter adjuster 30 is controlled by the system controller 5. The system controller 5 sets initial set values for each unit and receives measurement results and determined values.

The asymmetry measuring unit 32 calculates an asymmetry value based on a signal outputted from the RF circuit 3. The signal quality measuring unit 39 calculates a PRSNR or an error rate based on the signal outputted from the RF circuit 3. The bias power determining unit 36 determines a bias power based on the asymmetry value calculated by the a symmetry measuring unit 32 and the PRSNR calculated by the signal quality measuring unit 34 or based on the asymmetry value calculated by the asymmetry measuring unit 32 and the error rate calculated by the signal quality measuring unit 34. The recording power determining unit 38 determines a recording power based on the asymmetry value calculated by the asymmetry measuring unit 32 and the PRSNR calculated by the signal quality measuring unit 34 or based on the asymmetry value calculated by the asymmetry measuring unit 32 and the error rate calculated by the signal quality measuring unit 34. The bias power Pb determined by the bias power determining unit 36 and the recording power Pw determined by the recording power determining unit 38 are outputted to the LD driving unit 7.

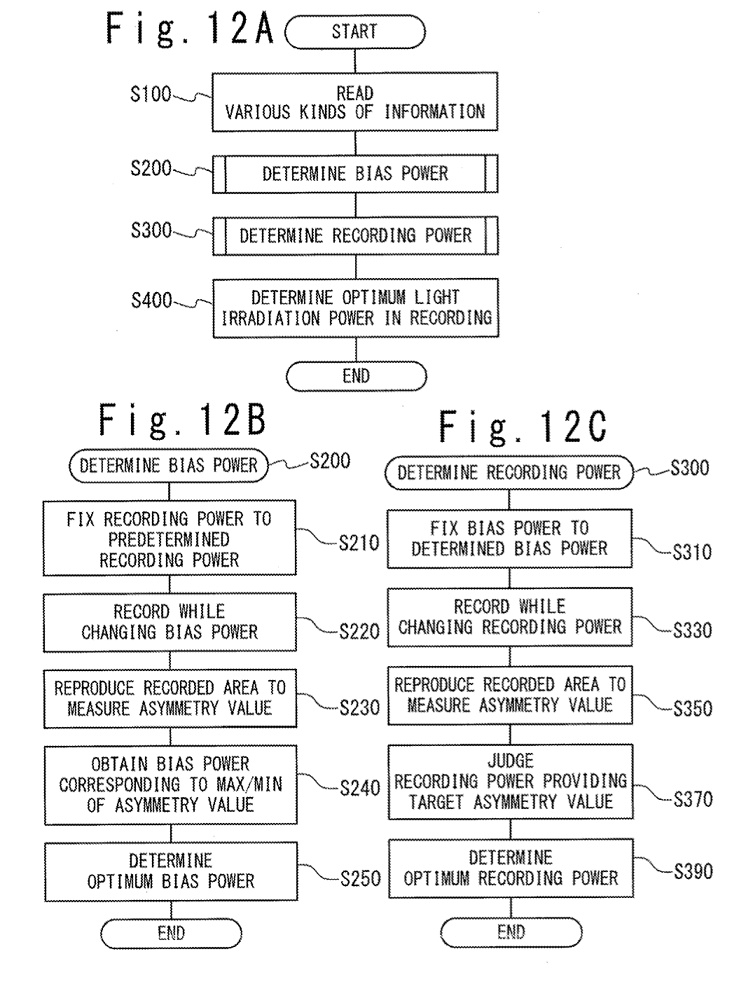

An operation for adjusting the bias power Pb and the recording power Pw in the information recording/reproducing apparatus will be described below with reference to FIGS. 12A to 12C. In the information recording/reproducing apparatus, after the loading of the optical disc 10, a disc type of the optical disc 10 is identified, and the optical head unit 20 is moved to a drive test zone of the optical disc 10. The drive test zone is an area to and from which the information recording/reproducing apparatus can record and reproduce test data in order to freely adjust the parameters. The information recording/reproducing apparatus detects an available area of the drive test zone and prepares for adjusting light irradiation powers.

In the adjusting method of the light irradiation powers (the bias power Pb and the recording power Pw) in recording to the optical disc 10, as shown in FIG. 12A, processes are carried out in an order of a step S100 for reading various kinds of information, a step S200 for determining the bias power, a step S300 for determining the recording power and a step S400 for determining the optimum light irradiation powers in recording.

In the step S100 for reading the various kinds of information, the various kinds of information are read from the loaded optical disc 10. The system controller 5 fetches information with regard to the power, target asymmetry values corresponding to the optimum recording powers and the like. The various kinds of information include: a format of the disc; a maker's name; Low-to-High medium (L/H medium) or High-to-Low medium (H/L medium) in a case of a recordable medium; number of recording layers; and the like. The Low-to-High medium means that a reflection factor of a mark is increased by recording a recording mark. The High-to-Low medium means that the reflection factor is decreased by recording the recording mark.

Next, the step S200 for determining the bias power is carried out. In the step S200 for determining the bias power, as shown in FIG. 12B, at first, the recording power is fixed to a predetermined value (Step S210). The value is an average recording power value of powers obtained in advance based on calibrations in which media available for experiments are used and a set value stored in the information recording/reproducing apparatus. The recording power value may be set based on the information with regard to the light irradiation powers recorded in the optical disc 10.

In a state in which the recording power is fixed, the recording is carried out while the bias power is being changed (Step S220). For example, the central value of the bias power to be changed is set to an average value of bias powers which are obtained through calibrations in experiments or the like in advance. Also, the changing range of the bias power is set to a range of about ±50% of the central value, and the changing width is set to a pitch width of about 0.5 mW. In this way, the recording is carried out while the bias power is being changed. By the way, when the nature of the optical disc 10 is clear from a disc identifier (Disk ID) and the like, the bias power can be adjusted at a higher precision by changing the bias power in the range of about ±10% at the pitch width of about 0.2 mW. By the way, the central power value of the bias power may be set based on the information with regard to the light irradiation powers recorded in the optical disc 10.

After the completion of the recording, the recorded area is reproduced, and the asymmetry measuring unit 32 calculates asymmetry values of the reproduction signals (Step S230). The calculated asymmetry values are changed correspondingly to the bias powers in the recording.

The bias power determining unit 36 determines the maximum or the minimum of the asymmetry values and selects the value of the bias power corresponding to the maximum or the minimum. Or, the bias power determining unit 36 determines the value of the bias power corresponding to the changing point of the increase amount or the decrease amount of the asymmetry value (Step S240). By the way, whether the maximum value or the minimum value is selected is judged by using information of a polarity of a mark (space) portion, which is recorded in the optical disc 10 in advance, or by using reflection factors of unrecorded portion/recorded portion.

The bias power determining unit 36 sets the bias power value selected in the step S240 as the optimum bias power value (Step S250).

Next, as shown in FIG. 12A, the step S300 for determining the optimum recording power is carried out. In the step S300 for determining the recording power, as shown in FIG. 12C, at first, the bias power is fixed to the optimum bias power value determined in the step S200 for determining the bias power (Step S310).

After that, in a state in which the bias power is fixed, the recording is carried out while the recording power is being changed (Step S330). For example, the central value of the recording power to be changed is set to an average value of recording powers which are obtained through calibrations in experiments or the like in advance. Also, the changing range of the recording power is set to a range of about ±15% of the central value, and the changing width is set to a pitch width of about 0.5 mW. In this way, the recording is carried out while the recording power is being changed. By the way, the central value of the recording power may be set to a power value indicated by the information recorded in the optical disc 10. When the nature of the optical disc 10 is clear from the Disk ID and the like, the adjustment can be carried out at a higher precision and a higher speed, by making the changing range of the recording power narrower and making the changing width of the recording power finer, for example, by using the range of about ±10% and the pitch of about 0.2 mW.

After the completion of the recording, the area is reproduced, and the asymmetry measuring unit 32 calculates asymmetry values of the reproduction signal (Step S350). The calculated asymmetry values are changed correspondingly to the recording power in the recording.

The recording power is judged which results in the target asymmetry value of the calculated asymmetry values (Step S370). The target asymmetry value is the asymmetry value corresponding to the optimum recording power which is read in the step S100 for reading the various kinds of information.

The recording power determining unit 38 sets the recording power judged in the step S370 as the optimum recording power value (Step S390).

In the step S400 for determining the optimum light irradiation powers in recording, the optimum bias power value and the optimum recording power value thus obtained are set in the LD driving unit 7, as the optimum light irradiation powers in recording to the optical disc 10 and applied in the following recording.

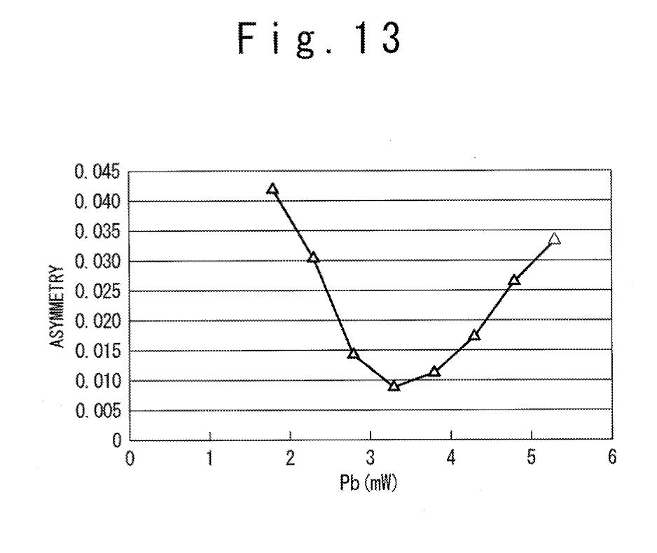

FIG. 13 shows examples of measurement results of asymmetry values when recording is carried out while the bias power is being changed and the recording power is being fixed and the recording area is reproduced. Here, the LD wavelength of the optical head unit 20 was 405 nm and the NA (Numeral Aperture) of the optical head unit 20 was 0.65. Also, as for the optical disc 10, a guide groove for in-groove format is formed on a polycarbonate substrate having a diameter of 120 mm and a thickness of 0.6 mm. As for the density of the recorded data, a bit pitch was 0.153 μm and a track pitch was 0.9 μm. This optical disc 10 is a write-once type medium in which an organic dye recording film for a short wavelength is used as a recording film.

The fixed recording power value is set to the recording power value (constant value) held as the information by the optical disc 10, and the bias power is changed within the range of ±2 mW with the bias power value as the center, which is held as the information by the optical disc 10. When the bias power value causing the asymmetry 2Tβ to be the minimum is assumed to be optimum, as shown in FIG. 13, it is found that the optimum bias power value of the bias power Pb is 3.2 mW.

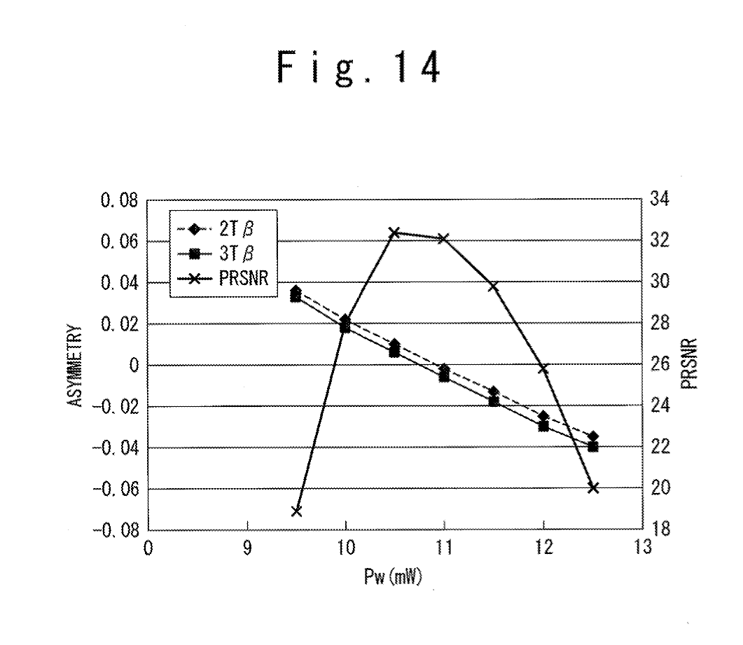

Next, by using the optimum bias power value obtained as described above, recording is carried out while the recording power is being changed with the average bias power as the center, which is held as the information by the information recording/reproducing apparatus. FIG. 14 shows measurement results of asymmetry values when the reproduction of the recorded area is carried out. Here, the recording power Pw is changed at a width of 0.5 mW from 9.5 mW to 12.5 mW, and the 2T asymmetry (2Tβ) and the 3T asymmetry 3Tβ are measured. According to the information obtained in the step 100 for reading the various kinds of information, the asymmetry value 2Tβ corresponding to the optimum recording power is +0.01. Then, the recording power value (10.5 mW) at that time is selected as the optimum recording power value. By the way, FIG. 14 shows results of the PRSNR measured to check the performance.

When the performance was measured for the selected powers in recording, the PRSNR was about 23, and the average value PISUM8 of block error numbers in 8-block estimation is about 10. Thus, it was verified that the adjustment was carried out such that the sufficient performance is provided. By the way, even if a case of the asymmetry value corresponding to the 3T, 3Tβ=+0.008 is selected, the similar result is obtained. From the foregoing results, the light irradiation powers in recording were adjusted at high speed and high precision, and the effectiveness of the information recording/reproducing apparatus and the adjusting method of light irradiation powers according to the present invention were verified.

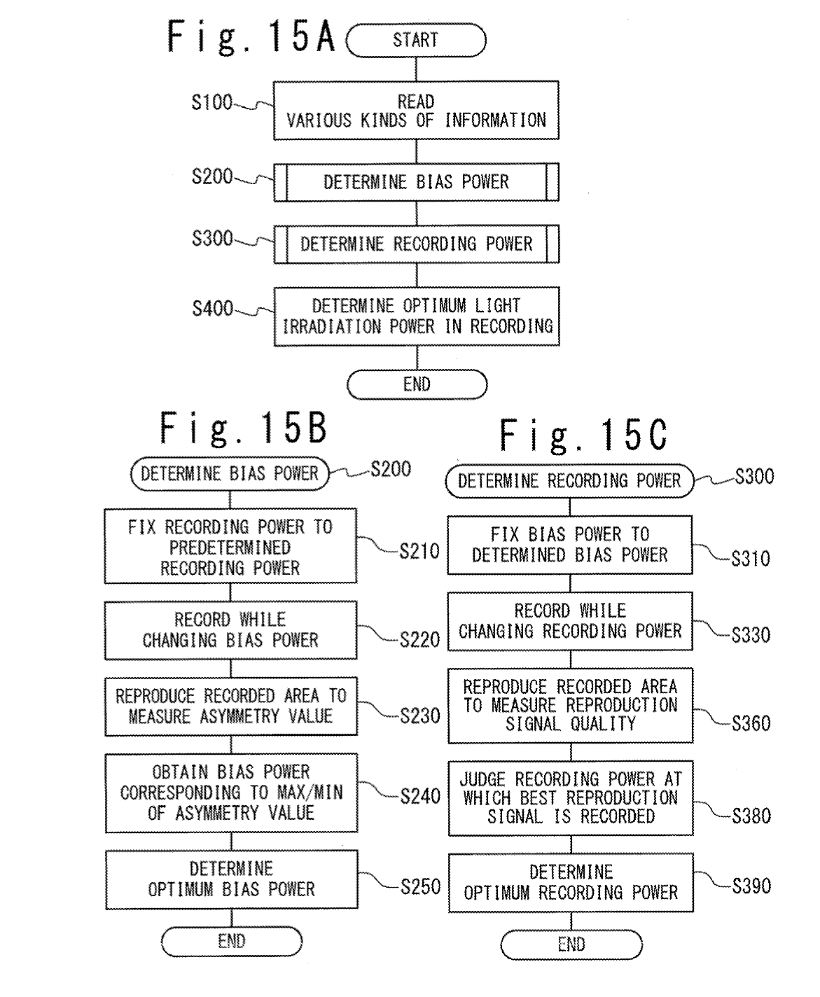

A second exemplary embodiment of the present invention will be described below with reference to the drawings. An information recording/reproducing apparatus according to the second exemplary embodiment has the same configuration as the information recording/reproducing apparatus according to the first exemplary embodiment, and the description of the configuration of the apparatus is omitted. Also, as shown in FIGS. 15A to 15C, an operation of the information recording/reproducing apparatus is different in processes in the step S300 for determining the recording power. The same numeral is provided to the same process, and its detailed description is omitted.

In the adjusting method of the light irradiation powers in recording to the optical disc 10 in the information recording/reproducing apparatus, as shown in FIG. 15A, processes are carried out in an order of a step S100 for reading various kinds of information, a step S200 for determining the bias power, a step S300 for determining the recording power and a step S400 for determining the optimum light irradiation powers in recording. In the step S100 for reading the various kinds of information and the step S200 for determining the bias power, the same processes as the first exemplary embodiment are carried out.

When the optical disc 10 is loaded, the information recording/reproducing apparatus identifies a type and a Disk ID of the medium. After that, the information recording/reproducing apparatus moves the optical head unit 20 to a drive test zone of the medium and detects an available area (Step S100). Various parameters such as light irradiation powers can be freely adjusted by using the drive test zone.

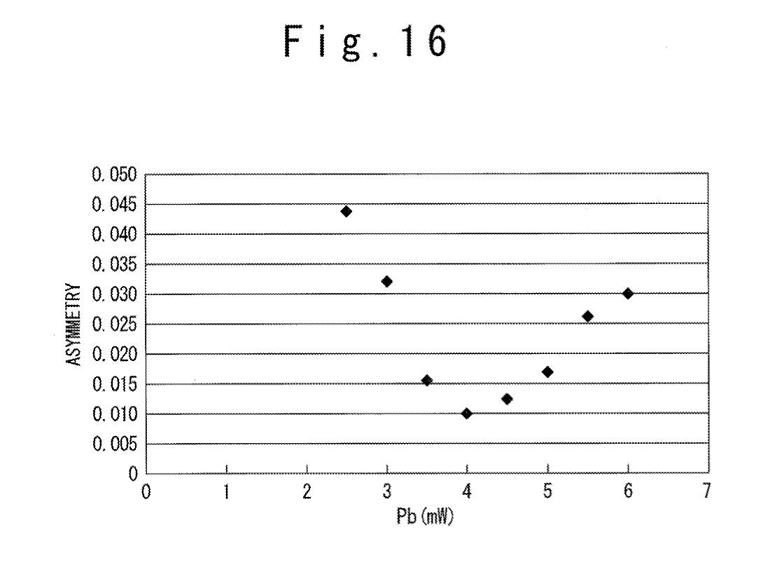

The information recording/reproducing apparatus holds as information, recommended recording power values and recommended bias power values which correspond to the respective Disk IDs. At first, the information recording/reproducing apparatus fixes the recording power to the recommended recording power selected based on the Disk ID (Step 210). In this state, the information recording/reproducing apparatus carries out recording while changing the bias power with the recommended bias power as the center, which is selected based on the Disk ID (Step S220). After that, the information recording/reproducing apparatus reproduces the recorded area to measure asymmetry values 2Tβ corresponding to 2T (Step S230). The measurement results are shown in FIG. 16.

The bias power determining unit 36 determines the maximum or the minimum of the asymmetry values and selects the value of the bias power corresponding to the maximum or the minimum. Or, the bias power determining unit 36 determines the value of the bias power corresponding to the changing point of the increase amount or the decrease amount of the asymmetry value (Step S240). Here, as shown in FIG. 16, 4.0 mW is determined as the bias power Pb at which the asymmetry value takes the minimum. The bias power determining unit 36 sets the bias power value selected in the step S240 as the optimum bias power value (Step S250).

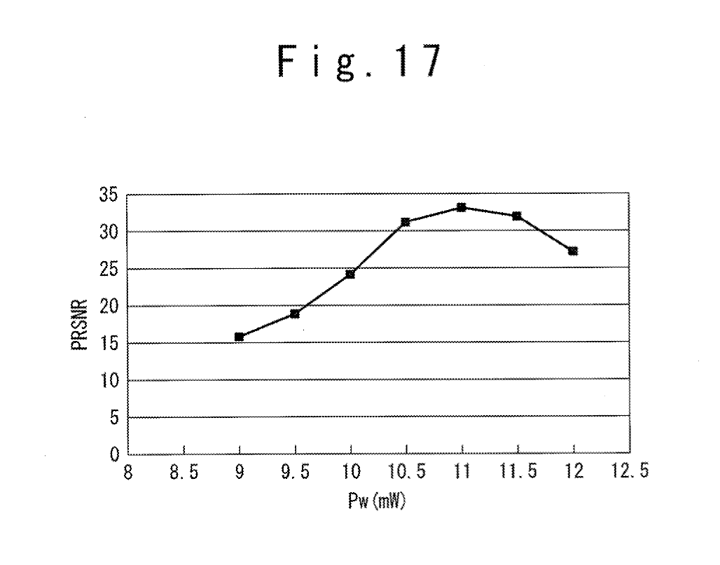

Next, the information recording/reproducing apparatus determines the optimum recording power. When the recording power is determined, the bias power is fixed to the optimum bias power value (4.0 mW) determined in the step S200 for determining the bias power (Step S310). In a state in which the bias power is fixed, the recording is carried out while the recording power is being changed (Step S330). After the completion of the recording, the area is reproduced, and the signal quality measuring unit 34 calculates a quality index of the reproduction signal (Step S360). The quality index is an index such as PRSNR, error rate, PI error number or the like, and indicating the performance of the medium. The measured results are shown in FIG. 17. Here, the measurement is carried out with the PRSNR as the signal quality.

The recording power determining unit 38 specifies the recording power in recording of the signal corresponding to the reproduction signal of which the signal quality is best (Step S380). In FIG. 17, it is found that the PRSNR takes the maximum at the recording power Pw of 11 mW and the optimum recording power value is 11 mW. That is, the recording power value as the light irradiation power in recording is set to 11 mW and the bias power value as the light irradiation power in recording is set to 4 mW. The recording power determining unit 38 sets the recording power value, which is specified in the step S380, as the optimum recording power (Step S390).

In the step S400 for determining the optimum light irradiation powers in recording, the optimum bias power, value and the optimum recording power value thus obtained are set in the LD driving unit 7, as the optimum light irradiation powers in recording to the optical disc 10 and applied in the following recording. By the way, as the signal quality of this time, PRSNR=about 33 is obtained.

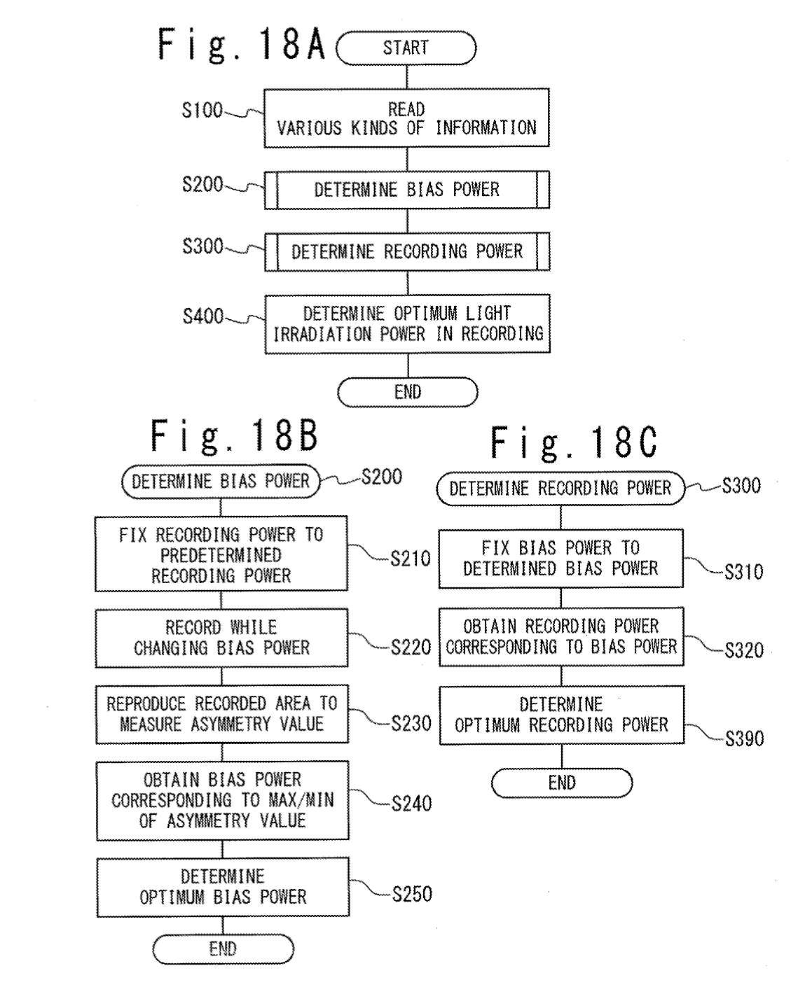

A third exemplary embodiment of the present invention will be described below with reference to the drawings. An information recording/reproducing apparatus according to the third exemplary embodiment has the same configuration as the information recording/reproducing apparatus according to the first exemplary embodiment, and the description of the configuration of the apparatus is omitted. Also, as shown in FIGS. 18A to 18C, an operation of the information recording/reproducing apparatus is different in processes in the step S300 for determining the recording power. The same numeral is provided to the same process, and its detailed description is omitted.

In the adjusting method of the light irradiation powers in recording to the optical disc 10 in the information recording/reproducing apparatus, as shown in FIG. 18A, processes are carried out in an order of a step S100 for reading various kinds of information, a step S200 for determining the bias power, a step S300 for determining the recording power and a step S400 for determining the optimum light irradiation powers in recording. In the step S100 for reading the various kinds of information and the step S200 for determining the bias power, the same processes as the first exemplary embodiment are carried out. Accordingly, the optimum bias power value is determined, and the step S300 for determining the recording power shown in FIG. 18C is started.

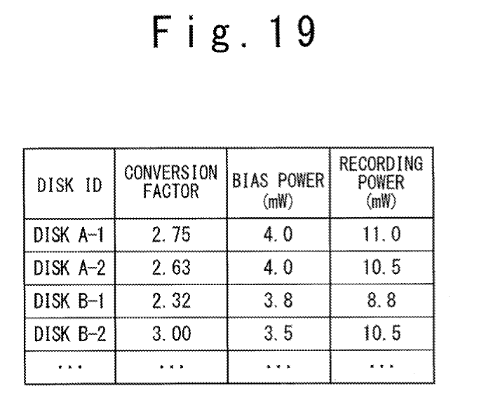

The bias power is fixed to the optimum bias power value determined in the step S200 for determining the bias power (Step S310). The recording power value is determined based on a conversion table. As shown in FIG. 19, the conversion table holds conversion factors such that the conversion factors are correlated to Disk IDs. The conversion factors are calibrated in advance correspondingly to optical discs, respectively. Thus, when the Disk ID of the loaded medium is identified, the recording power value can be calculated based on the conversion value in the conversion table and the optimum bias power value determined in the step S200 for determining the bias power. That is, the recording power is calculated by multiplying the optimum bias power value by the conversion factor (Step S320). By the way, FIG. 19 shows examples of the calculation of the recording power based on the bias power and the conversion factor in addiction to the conversion factors.

In the step S400 for determining the optimum light irradiation powers in recording, the optimum bias power value and the optimum recording power value thus obtained are set in the LD driving unit 7, as the optimum 1 fight irradiation powers in recording to the optical disc 10 and applied in the following recording.

The measurement results of the above adjusting method will be described below. As the optical disc 10, used was a medium configured such that a guide groove for in-groove format is formed on a polycarbonate substrate having a diameter of 120 mm and a thickness of 0.6 mm. As for the density of the recorded data, a bit pitch was 0.153 μm and a track pitch was 0.4 μm. Used was a disc medium (H/L medium) including an inorganic material recording film for a short wavelength, which was a medium of a type that recording to a recording film was possible at only one time.

When the optical disc 10 is loaded, the information recording/reproducing apparatus identifies a type and a Disk ID of the medium. Here, for example, the optical disc is assumed to be identified as a Disk A-2 as an H/L medium of a disc maker A. After that, the information recording/reproducing apparatus moves the optical head unit 20 to a drive test zone of the medium and detects an available area. Various parameters such as light irradiation powers can be freely adjusted by using the drive test zone.

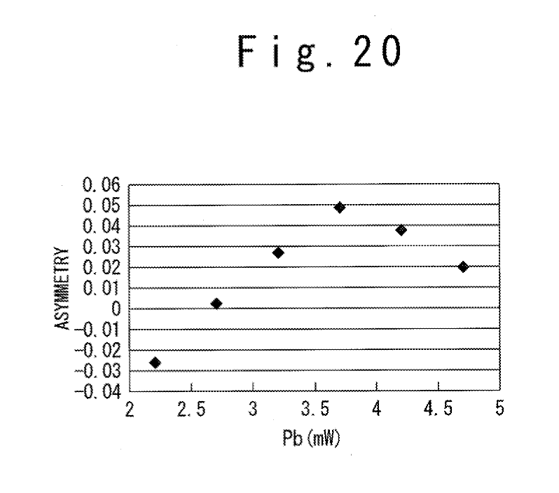

The information recording/reproducing apparatus holds as information, recommended recording power values and recommended bias power values which correspond to the respective Disk IDs. The information recording/reproducing apparatus selects the recommended recording power value corresponding to the Disk A-2 from them and fixes the recording power to the recommended recording power. The information recording/reproducing apparatus similarly selects the bias power value corresponding to the Disk A-2 based on the held information with regard to the recommended bias powers. The information recording/reproducing apparatus carries out recording while changing the bias power with the bias power value as the center. After that, the information recording/reproducing apparatus reproduces the recorded area to measure asymmetry values. The measurement results are shown in FIG. 20. As shown in FIG. 20, since the asymmetry value takes the maximum at the bias power of 3.7 mW, the optimum bias power value is selected as 3.7 mW. From the conversion table shown in FIG. 19, the recording power value is calculated as 9.7 mW based on the conversion factor corresponding to the Disk A-2.

That is, the recording power value as the light irradiation power in recording is set to 9.7 mW and the bias power value as the light irradiation power in recording is set to 3.7 mW. As for the signal quality at this time, the average value PISUM8 of block error numbers in 8ECC block estimation is about 20. Thus, it was verified that the recording/reproducing performance was acceptable. As mentioned above, the light irradiation powers in recording were adjusted at high speed and high precision, and the effectiveness of the information recording/reproducing apparatus and the adjusting method of light irradiation powers according to the present invention were verified.

A fourth exemplary embodiment of the present invention will be described below with reference to the drawings. An information recording/reproducing apparatus according to the fourth exemplary embodiment has the same configuration as the information recording/reproducing apparatus according to the first exemplary embodiment, and the description of the configuration of the apparatus is omitted.

At first, in the step S100 for reading the various kinds of information, the following information is also read. That is, the system controller 5 reads information with regard to a format of the optical disc, a disc maker, a polarity (L/H medium, H/L medium) of a mark portion and light irradiation powers, correction value information for the maximum value or the minimum value of the asymmetry values and the like.

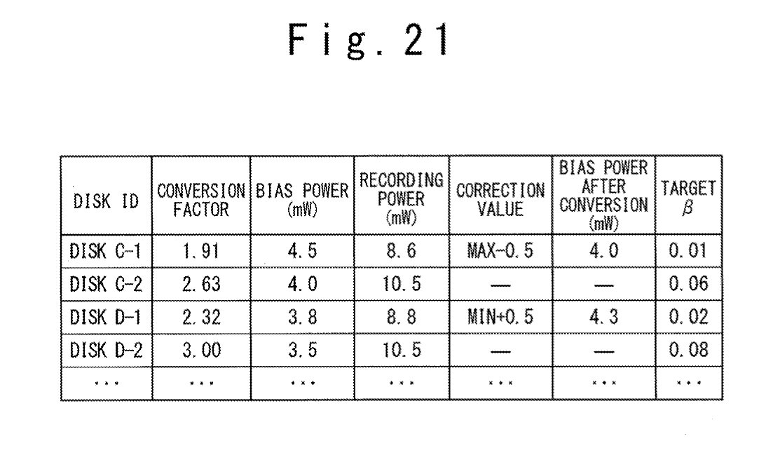

FIG. 21 is an example of a conversion table including the correction value information for the maximum value or the minimum value of the asymmetry values. In the correction value information, a difference between the maximum value or the minimum value and the value providing the best, of the asymmetry values is correlated to the Disk ID and is indicated. The difference is obtained in advance. The correction value information is effective for a medium with respect to which the performance of the reproduction signal is better when the bias power is deviated from the maximum or the minimum of the asymmetry.

In the step S240, a bias power corresponding to the maximum or the minimum of the asymmetry value is determined. In the step S250, the correction is carried out based on the bias power. As shown in FIG. 21, the conversion table including the correction value information indicates a difference between the bias power values when the asymmetry value is the maximum or the minimum and the bias power value when the reproduction signal has the best quality. For example, when the Disk ID is Disk C-1, “MAX-0.5” is given as the correction value. Thus, the optimum bias power value is determined by subtracting 0.5 mW from the bias power value at which the asymmetry value takes the maximum. Similarly, when the disc ID is Disk D-1, the optimum bias power value is determined by adding 0.5 mW to the bias power value at which the asymmetry value takes the minimum. By the way, any of the bias power value before the correction and the bias power value after the correction can be used as the bias power in calculating the recording power by using the conversion factor. In FIG. 21, the conversion factor corresponds to the bias power before the correction. The bias power value after the correction is also indicated. By the way, the correction value may be given as a multiplication factor such as MAX×0.95, MIN×1.15.

The measurement results of the above adjusting method will be described below. As the optical disc 10, used was a medium configured such that a guide groove for in-groove format is formed on a polycarbonate substrate having a diameter of 120 mm and a thickness of 0.6 mm. As for the density of the recorded data, a bit pitch was 0.153 μm and a track pitch was 0.4 μm. Used was a disc medium (H/L medium) including an inorganic material recording film for a short wavelength, which was a medium of a type that recording to a recording film was possible at only one time.

When the optical disc 10 is loaded, the information recording/reproducing apparatus identifies a type and a Disk ID of the medium. Here, for example, the optical disc is assumed to be identified as a Disk C-1 as an H/L medium of a disc maker C. After that, the information recording/reproducing apparatus moves the optical head unit 20 to a drive test zone of the medium and detects an available area. Various parameters such as light irradiation powers can be freely adjusted by using the drive test zone.

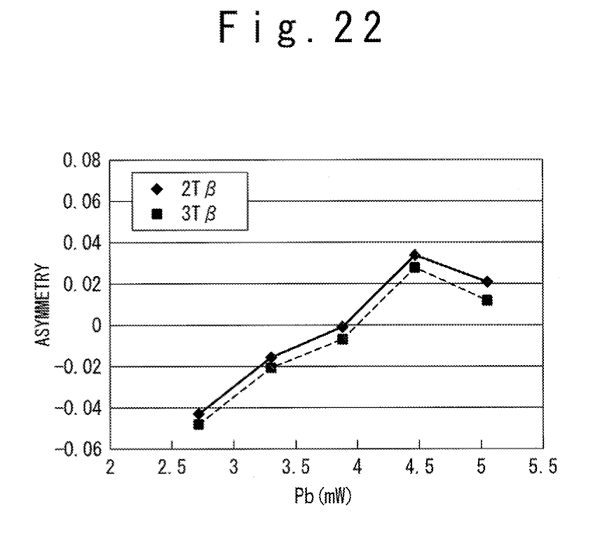

The information recording/reproducing apparatus holds as information, recommended recording power values and recommended bias power values which correspond to the respective Disk IDs. The information recording/reproducing apparatus selects the recommended recording power value corresponding to the Disk C-1 from them and fixes the recording power to the recommended recording power. The information recording/reproducing apparatus similarly selects the bias power value corresponding to the Disk C-1 based on the held information with regard to the recommended bias powers. The information recording/reproducing apparatus carries out recording while changing the bias power with the bias power value as the center. After that, the information recording/reproducing apparatus reproduces the recorded area to measure asymmetry values. The measurement results are shown in FIG. 22. As shown in FIG. 22, the asymmetry value takes the maximum at the bias power of 4.5 mW. As shown in FIG. 21, MAX-0.5 is specified as the correction value, the optimum bias power value is calculated as 4.0 mW. By the way, FIG. 22 shows 3T asymmetry values in addition to 2T asymmetry values. Even in the case of the 3T asymmetry value, it is verified that the asymmetry value similarly takes the maximum at the bias power of 4.5 mW.

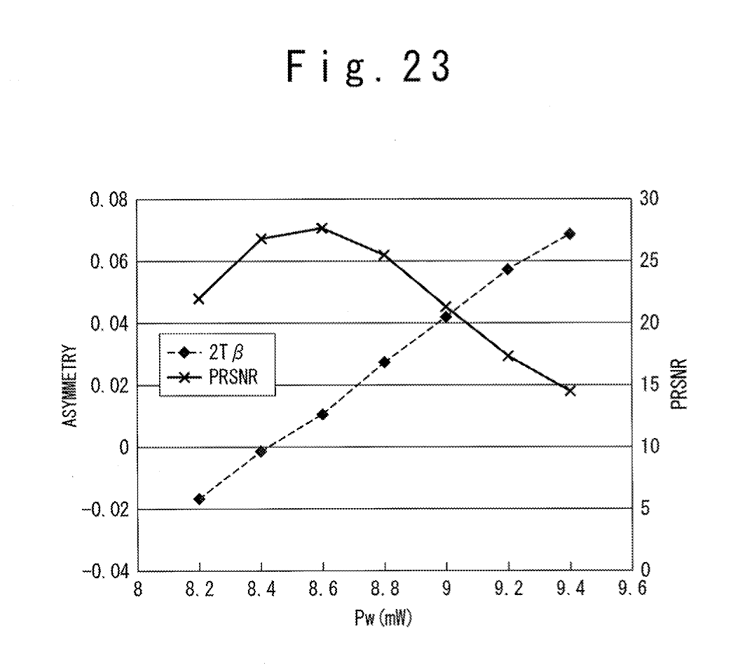

Next, the information recording/reproducing apparatus fixes the bias power to the corrected value of 4.0 mW and carries out recording while changing the recording power. The recorded area is reproduced to measure the asymmetry value. As shown in FIG. 21, since a target β of the Disk C-1 is 0.01, the recording power of 8.6 mW is selected at which the asymmetry value is 0.01. By the way, in order to verify the performance, the asymmetry value and the PESNR value are measured in a case that recording and reproducing are carried out while the recording power is being changed, and the results are shown in FIG. 23. It is verified that the PRSNR takes the highest at the recording power of 8.6 mW. Moreover, the adjusted optical irradiation powers in recording are set and the performance is verified by using the PI error as an index. As a result, the average value PISUM8 of block error numbers in 8ECC block estimation is about 15. Thus, it was verified that the recording/reproducing performance was acceptable.

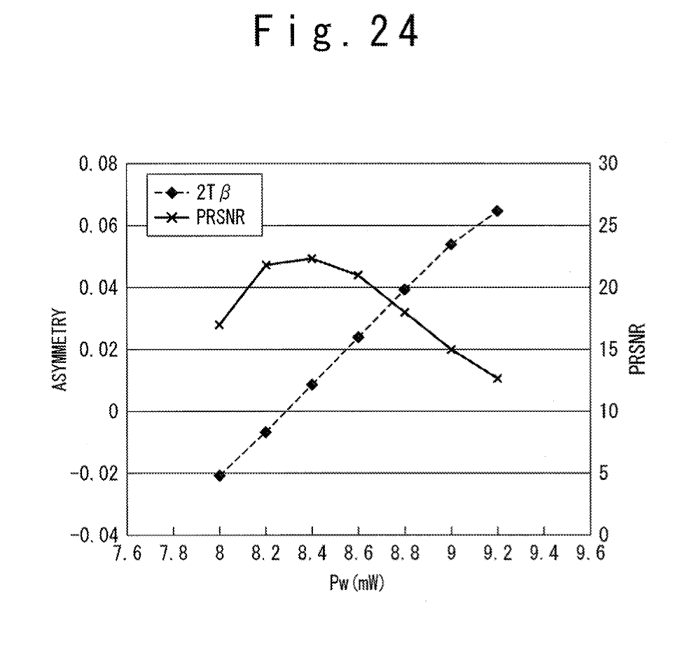

By the way, in order to compare the bias powers with and without correction, the bias power is set to the bias power of 4.5 mW at which the asymmetry takes the maximum, the recording is carried out while the recording power is being changed, and the recorded area is reproduced to measure the PRSNR and the asymmetry value. The results are shown in FIG. 24. At this time, the best PRSNR is 22, which indicates an acceptable performance. However, it is verified that the value is lower than that in FIG. 23 and does not necessarily indicate the best performance. As mentioned above, the light irradiation powers in recording were adjusted at high speed and high precision, and the effectiveness of the information recording/reproducing apparatus and the adjusting method of light irradiation powers according to the present invention were verified.

A fifth exemplary embodiment of the present invention will be described below with reference to the drawings. In the fifth exemplary embodiment, described is a case in which the loaded optical disc 10 is an unknown disc whose Disk ID cannot be identified in the step S100 for reading the various kinds of information. The unknown disc may be an optical disc which is unexpected by the information recording/reproducing apparatus, such as an optical disc which has not been appeared in the market at the time of the shipping of the information recording/reproducing apparatus.

The optical disc 10 is loaded into the information recording/reproducing apparatus and the system controller 5 reads the various kinds of information in the step S100 for reading the various kinds of information. Here, it is assumed that the identification of the disc maker of the optical disc 10 is impossible but the optical disc 10 is turn out to be a write-once medium in which the recording layer of the L/H polarity is the single layer and a guide groove for in-groove format is formed.

The information recording/reproducing apparatus moves the optical head to the drive test zone, detects an area available for the test, and records the test data in the area. At this time, the recording power is fixed to an average recording power for the L/H medium, which is held by the information recording/reproducing apparatus. Furthermore, the bias power is changed with an average bias power as the center. The average bias power is held by the information recording/reproducing apparatus. After the completion of the recording, the information recording/reproducing apparatus reproduces the recorded area to measure the asymmetry value. Although the measurement result is not shown, the asymmetry value took the minimum at the bias power of 3.8 mW.

Next, the bias power is set to 3.8 mW and the recording is carried out while the recording power is changed within the range of ±20% at a step width of 5% with the average bias power for the L/H medium as the center. After that, the information recording/reproducing apparatus reproduces the recorded area to measure the signal quality. At this time, the PRSNR is used as the performance index. When the recording power is between 10.5 mW and 11 mW, the PRSNR takes the maximum. Then, the recording power is calculated as 10.8 mW by using a generally-used peak value detecting algorism. In order to check the performance based on the PI, recording was carried out at the determined light irradiation powers in recording, reproduction was carried out, and PI error number was measured. As a result, the average value PISUM8 of block error numbers in 8-block estimation was 30.

The performance is acceptable, however, for confirmation, the PRSNR is used as an index, the recording power is set constant, recording is carried out again while the bias power is being changed, and the recorded area is reproduced. Here, the bias power is changed within the range of ±0.5 mW at a pitch of 0.2 mW with the center of 3.8 mW. The PRSNR is best at the bias power of 3.8 mW. It is judged to be impossible to improve the performance of the medium, and therefore the adjustment is terminated. By the way, the value of the 2T asymmetry β is zero at this time and the value is recorded as adjustment information indicating the adjustment by the apparatus in the drive test zone of the medium with an identifier (ID) of the apparatus. As mentioned above, the light irradiation powers in recording were adjusted at high speed and high precision, and the effectiveness of the information recording/reproducing apparatus and the adjusting method of light irradiation powers according to the present invention were verified.

The present invention is not limited to the apparatus of the wavelength of 405 nm and the NA of 0.65 but can be applied to apparatus of any wavelength and any NA. With regard to the waveform in recording, when the recording power corresponding to the mark has a plurality of levels, the adjustment of the recording power means the adjustment of powers with regard to the recording of the portion corresponding to the mark. For example, the adjustment can be carried out such that a ratio between a magnitude of recording peak power and a magnitude of next largest recording power is kept at a constant. Or, the powers can be changed independently. By the way, it is apparent that the present invention is not limited to the above exemplary embodiments but the exemplary embodiments can be modified within the technical idea of the present invention.

According to the adjusting method of light irradiation powers in recording by the optical recording/reproducing apparatus of the present invention, the recording is carried out by switching the intensity of the light beam irradiated correspondingly to the mark and the space between the recording power and the bias power, and the light irradiation powers can be adjusted at a high speed and a high precision in a case that the recording by using the light beam irradiation is carried out to the write-once recording medium of which the recording quality is changed depending on the change of both of the recording power and the bias power.

This is because a phenomenon is used in which the changing rate and the changing direction of the reflection factor of the space portion are different in above and below the specific temperature depending on the bias power corresponding to the space portion, the difference appears as the change in amplitude when the recorded pattern series is reproduced and the asymmetry is changed as a result. The phenomenon does not depend on the size of the recorded mark (The phenomenon occurs even when the recording power is not accurate). Thus, there is an effect that the adjustment time can be largely reduced as compared with an adjustment of powers with regard to recording, in which recording and reproducing are carried out by using all combinations of the powers. Moreover, there is an effect that the consumption of the adjustment area can be suppressed.

Also, as for the write-once recording medium in which the recording is carried out by switching the intensity of the light beam irradiated correspondingly to the mark and the space between the recording power and the bias power and the recording quality is changed depending on the change of both of the bias power and the recording power, the adjustment with regard to the selection of both of the bias power and the recording power can be carried out by using the common index (asymmetry). Consequently, it is not necessary to carry out a complex process such as a process using different scales, various device resources can be reduced, and the cost can be reduced. In addition, when the asymmetry value measuring circuit is configured only by analog circuits, as for the measurement value, there is an advantage that a characteristic change by a scratch, a defect, a dust or the like is hard to occur and a stability of the measurement of the performance is improved.

Moreover, in view of current circumstances in which a management in the apparatus (a management in which adjustment values respectively corresponding to media are installed in the apparatus) cannot catch up an explosive increase in a number of media makers, the fact that the parameters contributing to the performance can be adjusted at a high speed and a high accuracy leads to the application to various media, and there is an advantage that the convenience of users is improved and a high reliability is secured. In particular, the advantage is important in a case that there is no information of the asymmetry value corresponding to the optimum power, because of the unknown disc.

As mentioned above, the present invention has been described by referring to the exemplary embodiments. However, the present invention is not limited tc the above-mentioned exemplary embodiments. Various modifications that can be understood by those skilled in the art within the scope of the present invention can be applied to the configurations and details of the present invention.

1. A light irradiation power adjusting method comprising:
recording an adjustment pattern to an optical information recording medium while fixing a recording power of a light beam, which is irradiated to said optical information recording medium correspondingly to a mark portion of a code to be recorded, to a predetermined first power value and while changing a bias power of said light beam, which is irradiated correspondingly to a space portion of said code, among a plurality of second power values within a predetermined range;
reproducing said adjustment pattern recorded so as to generate a reproduction signal;
measuring based on said reproduction signal, asymmetry values respectively corresponding to said plurality of second power values;
determining an optimum bias power value based on said asymmetry values; and
determining an optimum recording power value based on said optimum bias power value.

2. The light irradiation power adjusting method according to claim 1, wherein said determining said optimum bias power value includes:
obtaining a maximum value or a minimum value of said asymmetry values; and
determining said optimum bias power value based on a power value of said plurality of second power values, which provides said maximum value or said minimum value of said asymmetry values.

3. The light irradiation power adjusting method according to claim 1, wherein said determining said optimum bias power value includes:
calculating an increase/decrease amount of said asymmetry values, which increases or decreases correspondingly to said plurality of second power values; and
determining said optimum bias power value based on a power value of said plurality of second power values, which corresponds to a characteristic asymmetry value of a characteristic point at which said increase/decrease amount changes.

4. The light irradiation power adjusting method according to claim 1, wherein said determining said optimum recording power value includes:
recording a second adjustment pattern to said optical information recording medium while fixing said bias power to said optimum bias power value and while changing said recording power among a plurality of third power values within a predetermined range;
reproducing said second adjustment pattern to generate a second reproduction signal;
measuring based on said second reproduction signal, reproduction signal quality values respectively corresponding to said plurality of third power values;
obtaining a best reproduction signal quality value of said reproduction signal quality values; and
determining as said optimum recording power value, a power value of said plurality of third power values, at which said second adjustment pattern corresponding to said best reproduction signal quality value is recorded.

5. The light irradiation power adjusting method according to of claim 1, wherein said determining said optimum recording power value includes determining said optimum recording power based on said optimum bias power value and a correspondence table indicating a correspondence relation between said recording power and said bias power, which is set in advance.

6. The light irradiation power adjusting method according to claim 5, further comprising for reading said correspondence table stored in said optical information recording medium.

7. An optical information recording/reproducing apparatus comprising:
an optical head unit configured to record an adjustment pattern to an optical information recording medium while switching between a recording power of an light beam, which is irradiated to said optical information recording medium correspondingly to a mark portion of a code to be recorded, and a bias power of said light beam, which is irradiated correspondingly to a space portion of said code and to reproduce said adjustment pattern recorded so as to generate a reproduction signal;
a control unit configured to set said recording power and said bias power such that said recording power is fixed to a predetermined first power value and said bias power is changed among a plurality of second power values within a predetermined range;
an asymmetry measuring unit configured to measure based on said reproduction signal, asymmetry values respectively corresponding to said plurality of second power values;
a bias power determining unit configured to determine an optimum bias power based on said asymmetry values; and
a recording power determining unit configured to determine an optimum recording power value as an optimum value of said recording power based on said optimum bias power value.

8. The optical information recording/reproducing apparatus according to claim 7, wherein said bias power determining unit obtains a maximum value or a minimum value of said asymmetry values, and determines an optimum bias power value based on a power value of said plurality of second bias power values, which provides said maximum value or said minimum value of said asymmetry values.

9. The optical information recording/reproducing apparatus according to claim 7, wherein said bias power determining unit calculates an increase/decrease amount of said asymmetry values, which increases or decreases correspondingly to said plurality of second power values, and determines said optimum bias power value based on a power value of said plurality of second power values, which corresponds to a characteristic asymmetry value of a characteristic point at which said increase/decrease amount changes.

10. The optical information recording/reproducing apparatus according to claim 7, wherein said control unit sets said bias power and said recording power such that said bias power is fixed to said optimum bias power value and said recording power is changed among a plurality of third power values within a predetermined range,
said optical head unit switches between said recording power and said bias power which are set so as to record a second adjustment pattern to said information recording medium and reproduces said second adjustment pattern recorded so as to generate a second reproduction signal, and
said recording power determining unit includes a reproduction signal quality measuring unit configured to measure based on said second reproduction signal, signal qualities respectively corresponding to said plurality of third power values and determines as said optimum recording power value, a power value of said plurality of third power values, at which said second adjustment pattern providing a best of said signal qualities is recorded.

11. The optical information recording/reproducing apparatus according to claim 7, wherein said recording power determining unit includes:
a database holding said bias power and said optimum recording power such that said bias power and said optimum recording power are correlated to each other; and
an optimum recording power determining unit configured to determine said optimum recording power value based on said optimum bias power value by referring to said data base.

12. The optical information recording/reproducing apparatus according to claim 11 reads from said optical information recording medium, a said database which is stored in said optical information recording medium.
